(19) United States
(12) Patent Application Publication
(10) Pub. No.: US 2026/0239401 A1
(43) Pub. Date: Aug. 13, 2026

(54) TERMINAL AND RADIO COMMUNICATION METHOD

(71) Applicant: NTT DOCOMO, INC., Tokyo (JP)

(72) Inventors: Shohei YOSHIOKA, Tokyo (JP); Taichi SHICHIJO, Tokyo (JP); Satoshi NAGATA, Tokyo (JP)

(73) Assignee: NTT DOCOMO, INC., Tokyo (JP)

(21) Appl. No.: 19/156,489

(22) PCT Filed: Feb. 17, 2023
(86) PCT No.: PCT/JP2023/005805

§ 371 Date: Aug. 14, 2025

(51) Int. Cl. H04W 72/40; H04L 1/1829

(52) U.S. Cl. CPC H04W 72/40; H04L 1/1854

(57) ABSTRACT

A terminal includes a communication unit that performs communication of a sidelink channel, and a control unit that controls the communication of the sidelink channel, in which the control unit controls transmission of the sidelink channel by a specific method when two or more transmission occasions are usable as a transmission occasion of a sidelink feedback channel transmitting a feedback.

### TECHNICAL FIELD

The present disclosure relates to a terminal and a radio communication method compatible with communication of a sidelink channel.

### BACKGROUND ART

In Long Term Evolution (LTE) and LTE successor systems (for example, LTE-A (LTE Advanced) and New Radio (NR) (also referred to as 5G)), Device to Device (D2D) technologies in which terminals directly communicate with each other without using a base station are discussed (for example, Non-Patent Literature 1).

The D2D reduces traffic between the terminal and the base station, and enables communications between terminals even if the base station is unable to perform communications in the event of a disaster or the like. Note that in 3rd Generation Partnership Project (3GPP (registered trademark)), the D2D is referred to as “sidelink”, but the more common term “D2D” will be used in the present specification. However, in the following embodiments, “sidelink” is also used as necessary.

The D2D communication is classified as D2D discovery for discovering another terminal capable of communication (also referred to as D2D discovery), and D2D communication for directly communicating between terminals (also referred to as D2D direct communication, D2D communication, terminal-to-terminal direct communication, or the like). Hereinafter, when the D2D communication, the D2D discovery, and the like are not distinguished particularly, they are simply called D2D. A signal to be transmitted or received using the D2D is referred to as a D2D signal. Various use cases of services used in Vehicle to Everything (V2X) in NR are discussed (for example, Non-Patent Literature 2).

NR release 17 (for example, Non-Patent Literature 3) discusses using a higher frequency band than a conventional release. For example, applicable numerologies including subcarrier spacings, channel bandwidths, and the like, physical layer design, and possible failures in actual radio communication, and the like in the frequency band from 52.6 GHz to 71 GHz have been discussed.

### CITATION LIST

### Non-Patent Literatures

Non-Patent Literature 1:3GPP TS 38.211 V 17.3.0 (2022-09)

Non-Patent Literature 2:3GPP TR 22.886 V 16.2.0 (2018-12)

Non Patent Literature 3:3GPP TS 38.306 V 17.2.0 (2022-09)

Non Patent Literature 4:3GPP TS 37.213 V 17.3.0 (2022-09)

### SUMMARY OF INVENTION

Meanwhile, in the D2D communication, there is a physical sidelink feedback channel (PSFCH) for transmitting feedback to a physical sidelink control channel (PSCCH) /physical sidelink shared channel (PSSCH). Since it is assumed that the transmission of PSFCH is not performed due to a factor such as a Listen Before Talk (LBT) failure, it has been discussed to enable two or more transmission periods of PSFCH (PSFCH occasion) to be used for a certain PSCCH/PSSCH.

Under such circumstances, as a result of intensive studies, the inventors have found a need to clarify a procedure related to transmission of a sidelink channel (PSCCH/PSSCH/PSFCH) in a case where two or more PSFCH occasions can be used for a certain PSCCH/PSSCH.

Therefore, the present disclosure has been made to solve the above-described problems, and an object thereof is to provide a terminal and a radio communication method capable of appropriately transmitting a sidelink channel (PSCCH/PSSCH/PSFCH) in a case where two or more PSFCH occasions can be used for a certain PSCCH/PSSCH.

One aspect of the disclosure is a terminal including: a communication unit that performs communication of a sidelink channel; and a control unit that controls the communication of the sidelink channel, in which the control unit controls transmission of the sidelink channel by a specific method when two or more transmission occasions are usable as a transmission occasion of a sidelink feedback channel transmitting a feedback.

One aspect of the disclosure is a radio communication method including: a step A of performing communication of a sidelink channel; and a step B of controlling the communication of the sidelink channel, in which the step A includes a step of controlling transmission of the sidelink channel by a specific method when two or more transmission occasions are usable as a transmission occasion of a sidelink feedback channel transmitting a feedback.

### BRIEF DESCRIPTION OF DRAWINGS

FIG. 1 is a diagram for explaining V2X.

FIG. 2 is a sequence chart illustrating an example (1) of V2X operation.

FIG. 3 is a sequence chart illustrating an example (2) of V2X operation.

FIG. 4 is a sequence chart illustrating an example (3) of V2X operation.

FIG. 5 is a sequence chart illustrating an example (4) of V2X operation.

FIG. 6 is a diagram illustrating an example of a sensing operation.

FIG. 7 is a flowchart for explaining an example of a preemption operation.

FIG. 8 is a diagram illustrating an example of the preemption operation.

FIG. 9 is a diagram illustrating an example of a partial sensing operation.

FIG. 10 is a diagram for explaining an example of periodic-based partial sensing.

FIG. 11 is diagram for explaining an example of contiguous partial sensing.

FIG. 12 is a diagram illustrating an example of a frequency range in an embodiment.

FIG. 13 is a diagram for explaining an example (1) of LBT.

FIG. 14 is a diagram for explaining an example (2) of LBT.

FIG. 15 is a diagram for explaining an example (3) of LBT.

FIG. 16 is a diagram for explaining parameters for each channel access priority class p.

FIG. 17 is a diagram for describing Operation Example 1.

FIG. 18 is a diagram for describing Operation Example 2.

FIG. 19 is a diagram for describing Operation Example 2.

FIG. 20 is a diagram illustrating an example of a functional configuration of a base station 10 in an embodiment.

FIG. 21 is a diagram illustrating an example of a functional configuration of a terminal 20 in an embodiment.

FIG. 22 is a diagram illustrating an example of a hardware configuration of the base station 10 or the terminal 20 in an embodiment.

FIG. 23 is a diagram illustrating an example of a configuration of a vehicle 2001 in an embodiment.

### DESCRIPTION OF EMBODIMENTS

Hereinafter, an embodiment will be described with reference to the drawings. Note that the embodiment described below is merely an example, and the embodiment is not limited to the following disclosure.

### (Embodiment

In the operation of a radio communication system of the embodiment, existing techniques are used as appropriate. However, the existing techniques include, for example, existing LTE, but are not limited to the existing LTE. The term “LTE” used in the present specification broadly means LTE-Advanced and systems (e.g. NR) used after LTE-Advanced, or a wireless local area network (LAN), unless otherwise stated.

In the embodiment, a duplex system may include a Time Division Duplex (TDD) system, a Frequency Division Duplex (FDD) system, or other systems (for example, Flexible Duplex, or the like).

In the embodiment, “configure” used for a wireless parameter or the like may mean that a predetermined value is pre-configured, or that a wireless parameter indicated by a base station 10 or a terminal 20 is configured.

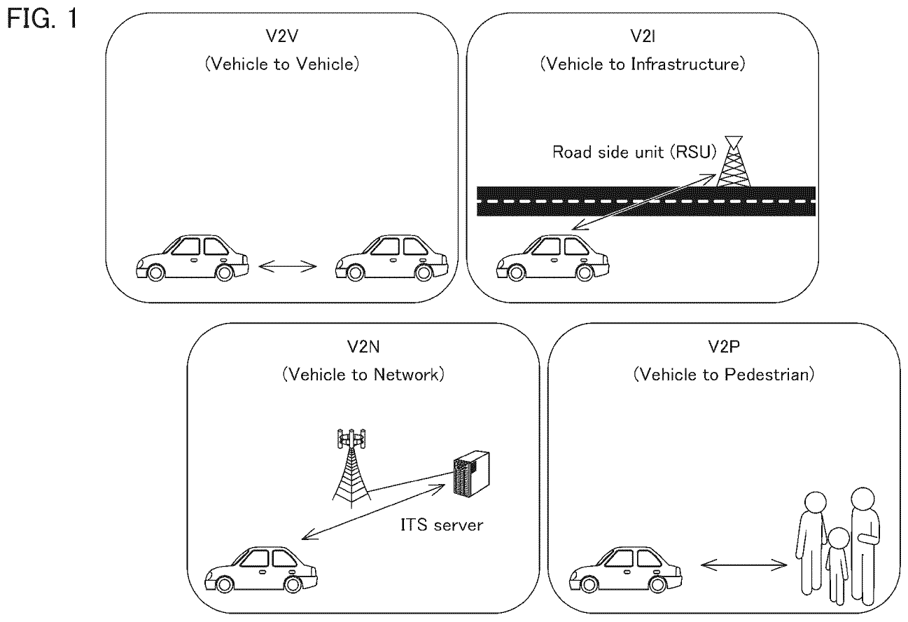

FIG. 1 is a diagram for explaining V 2X. In 3GPP, by extending a D2D function, implementation of Vehicle to Everything (V2X) or enhanced V2X (eV2X) is reviewed, and their specifications are discussed. As illustrated in FIG. 1, V2X is a part of Intelligent Transport Systems (ITS), and is a generic term of Vehicle to Vehicle (V2V) meaning a manner of communication performed between vehicles, Vehicle to Infrastructure (V2I) meaning a manner of communication performed between a vehicle and a road-side unit (RSU) installed on a road side, Vehicle to Network (V2N) meaning a manner of communication performed between a vehicle and an ITS server, and Vehicle to Pedestrian (V2P) meaning a manner of communication performed between a vehicle and a mobile terminal carried by a pedestrian.

In 3GPP, V2X using cellular communication and inter-terminal communication in LTE or NR is studied. V2X using cellular communication is also referred to as cellular V2X. In V2X in NR, studies for allowing large capacity, low delay, high reliability, and a Quality of Service (Qos) control are boosted.

For V2X in LTE or NR, discussions that are not limited to 3GPP technical specification development are expected in a future. For example, securing of interoperability, cost reduction by implementing a higher layer, a method of combining or switching of a plurality of Radio Access Technologies (RATs), regulation actions in each country, and data acquisition for a V2X platform in LTE or NR, delivery, database management, and a use method, are expected to be discussed.

In the embodiment, a case is mainly assumed in which a communication device is mounted on a vehicle, but the embodiment is not limited to such a case. For example, the communication device may be a terminal carried by a person, or the communication device may be a device provided in a drone or an aircraft, and the communication device may include a base station, an RSU, a relay station (relay node), a terminal having a scheduling capability, or the like.

Note that Sidelink (SL) may be distinguished from Uplink (UL) or Downlink (DL) on the basis of one of the following 1) to 4) or a combination thereof. SL may be referred to by another name.
1) Resource arrangement in a time domain
2) Resource arrangement in a frequency domain
3) Synchronization signal to be referred to (including a sidelink synchronization signal (SLSS))
4) Reference signal used in path loss measurement for a transmission power control

For Orthogonal Frequency Division Multiplexing (OFDM) in SL or UL, any from among Cyclic-Prefix OFDM (CP-OFDM), Discrete Fourier Transform-Spread-OFDM (DFT-S-OFDM), OFDM in which Transform precoding is not performed, and OFDM in which Transform precoding is performed, may be applied.

In SL in LTE, Mode 3 and Mode 4 are defined for SL resource allocation to the terminal 20. In Mode 3, transmission resources are dynamically allocated in accordance with Downlink Control Information (DCI) transmitted from the base station 10 to the terminal 20. In Mode 3, Semi Persistent Scheduling (SPS) can be also performed. In Mode 4, the terminal 20 autonomously selects transmission resources from a resource pool.

Note that a slot in the embodiment may be replaced with a symbol, a mini slot, a subframe, a radio frame, or a transmission time interval (TTI). The slot is an example of a unit time, and may be replaced with a term indicating a different unit time. A cell in the embodiment may be replaced with a cell group, a carrier component, a BWP, a resource pool, a resource, a Radio Access Technology (RAT), a system (including a wireless LAN), or the like.

Note that, in the embodiment, the terminal 20 is not limited to a V2X terminal, and may be any type of terminal that performs D2D communication. For example, the terminal 20 may be a terminal that is carried by a user, such as a smartphone, or may be an Internet of Things (IOT) device such as a smart meter.

In NR-SL, it is assumed that a hybrid automatic repeat request (HARQ) is supported for unicasts and groupcasts of sidelinks. In NR-V2X, Sidelink Feedback Control Information (SFCI) including an HARQ response is defined. The transmission of SFCI via a physical sidelink feedback channel (PSFCH) is also under consideration.

Note that, in the following description, the PSFCH is used for transmitting a sidelink HARQ-ACK, but this is an example. For example, PSCCH may be used to transmit a sidelink HARQ-ACK, PSSCH may be used to transmit a sidelink HARQ-ACK, or other channels may be used to transmit sidelink HARQ-ACK.

Hereinafter, for the sake of convenience, the overall information reported by the terminal 20 in HARQ may be called HARQ-ACK. This HARQ-ACK may also be referred to as HARQ-ACK information. More specifically, the codebook applied to the HARQ-ACK information reported from the terminal 20 to the base station 10 and the like is called the HARQ-ACK codebook. The HARQ-ACK codebook defines a bit sequence of HARQ-ACK information. Note that NACK is also transmitted in addition to ACK by “HARQ-ACK”.

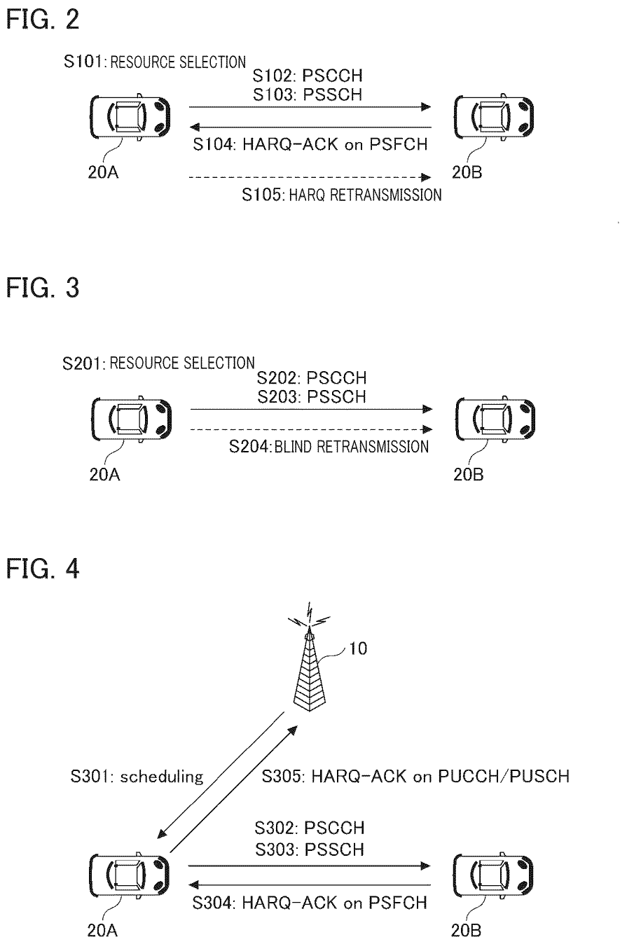

FIG. 2 is a sequence chart illustrating an example (1) of V2X operation. As illustrated in FIG. 2, a radio communication system according to an embodiment may have a terminal 20A and a terminal 20B. Note that there are many user apparatuses in actuality, but FIG. 2 illustrates the terminal 20A and the terminal 20B as examples.

Hereinafter, when the terminals 20A, 20B, and the like are not particularly distinguished, they are simply described as “terminal 20” or “user apparatuses”. FIG. 2 illustrates, as an example, a case where the terminal 20A and the terminal 20B are both in cell coverage, but the operation in the embodiment is also applicable when the terminal 20B is outside of coverage.

As described above, in the present embodiment, the terminal 20 is, for example, a device mounted on a vehicle such as an automobile, and has a function of cellular communication as a UE in LTE or NR and a sidelink function. The terminal 20 may be a general portable terminal (such as a smartphone). The terminal 20 may also be an RSU. The RSU may be a UE-type RSU having the function of a UE or a gNB-type RSU having the function of a base station apparatus.

Note that the terminal 20 need not be a single housing device, and for example, even when various sensors are distributed throughout the vehicle, the device including the various sensors may be the terminal 20.

The processing contents of the transmission data of sidelink of the terminal 20 are basically the same as the processing contents of the UL transmission in LTE or NR. For example, the terminal 20 scrambles the code words of the transmission data, modulates them to generate complex-valued symbols, and maps the complex-valued symbols (transmission signals) to one or two layers for precoding. The precoded complex-valued symbols are then mapped to resource elements to generate a transmission signal (e.g. complex-valued time-domain SC-FDMA signal), which is transmitted from each antenna port.

Note that the base station 10 has a function of cellular communication as a base station in LTE or NR, and a function to enable the communication of the terminal 20 in the present embodiment (e.g. resource pool configuration, resource allocation, and the like). The base station 10 may be an RSU (gNB-type RSU).

In the radio communication system according to the embodiment, a signal waveform used by the terminal 20 for SL or UL may be OFDMA, SC-FDMA, or another signal waveform.

The terminal 20 transmits a sidelink synchronization signal block (S-SSB) as a synchronization signal in SL. The S-SSB may include a sidelink primary synchronization signal (S-PSS), a sidelink secondary synchronization signal (S-SSS), and a physical sidelink broadcast channel (PSBCH). Note that the names of S-SSB, S-PSS, S-SSS, and the like are examples, and may be names other than S-SSB, S-PSS, S-SSS, and the like.

The terminal 20 transmits the S-SSB to another terminal 20 on the basis of a signal received from the base station apparatus 10, a global navigation satellite system (GNSS) signal, or a signal received from another terminal 20. Note that when the terminal 20 cannot transmit the S-SSB on the basis of any signal of the base station apparatus 10, the GNSS, and another terminal 20, the terminal 20 may transmit the autonomously determined S-SSB to another terminal 20. A resource available for the S-SSB may be a periodic slot, and may be referred to as an S-SSB occasion.

In step S101, the terminal 20A autonomously selects resources to be used for PSCCH and PSSCH from a resource selection window having a predetermined time period. The resource selection window may be configured from the base station 10 to the terminal 20. Here, for the predetermined time period of the resource selection window, the time period may be defined by the terminal implementation conditions such as processing time or maximum allowable packet delay time, or the time period may be defined in advance by specifications, or the predetermined time period may be called a section in the time domain.

In step S102 and step S103, the terminal 20A transmits Sidelink Control Information (SCI) by PSCCH and/or PSSCH and SL data by PSSCH, using the resources selected autonomously in step S101. For example, the terminal 20A may transmit the PSCCH using a frequency resource adjacent to or not adjacent to the frequency resource of the PSSCH in the same time resource as at least a part of the time resource of the PSSCH.

The terminal 20B receives the SCI (PSCCH and/or PSSCH) and SL data (PSSCH) transmitted from the terminal 20A. The received SCI may include information of the PSFCH resources for the terminal 20B to transmit an HARQ-ACK for receiving the data. The terminal 20A may include information of the autonomously selected resources in the SCI and transmit it. Note that the resource usable for the PSFCH may be a periodic slot and a symbol at the end (excluding the last symbol) in the slot, and may be referred to as a PSFCH occasion.

In step S104, the terminal 20B transmits an HARQ-ACK for the received data to the terminal 20A using the resources of the PSFCH determined from the received SCI.

In step S105, the terminal 20A retransmits the PSCCH and PSSCH to the terminal 20B when the HARQ-ACK received in step S104 indicates that retransmission is requested, that is, in the case of NACK (negative response). The terminal 20A may retransmit the PSCCH and PSSCH using autonomously selected resources.

Note that, when the HARQ control with HARQ feedback is not performed, step S104 and step S105 need not be performed.

FIG. 3 is a sequence chart illustrating an example (2) of V2X operation. A blind retransmission without HARQ control may be performed to improve transmission success rate or reachability.

In step S201, the terminal 20A autonomously selects resources to be used for PSCCH and PSSCH from a resource selection window having a predetermined time period. The resource selection window may be configured from the base station 10 to the terminal 20.

In step S202 and step S203, the terminal 20A transmits SCI by PSCCH and/or PSSCH, using the resources selected autonomously in step S201, and transmits SL data by PSSCH. For example, the terminal 20A may transmit the PSCCH using a frequency resource adjacent to the frequency resource of the PSSCH in the same time resource as at least a part of the time resource of the PSSCH.

In step S204, the terminal 20A retransmits the SCI by PSCCH and/or PSSCH and the SL data by PSSCH to the terminal 20B, using the resources selected autonomously in step S201. The retransmission in step S204 may be performed a plurality of times.

Note that, when blind retransmission is not performed, step S204 need not be performed.

FIG. 4 is a sequence chart illustrating an example (3) of V2X operation. The base station 10 may perform a sidelink scheduling. That is, the base station 10 may determine the resources of the sidelink to be used by the terminal 20 to transmit information indicating the resources to the terminal 20. When HARQ control with HARQ feedback is applied, the base station 10 may transmit information indicating the resources of PSECH to the terminal 20.

In step S301, the base station 10 performs SL scheduling by transmitting Downlink Control Information (DCI) to the terminal 20A by PDCCH. Hereinafter, for the sake of convenience, the DCI for SL scheduling is called SL scheduling DCI.

In step S301, it is assumed that the base station 10 also transmits DCI for DL scheduling (which may be called DL allocation) to the terminal 20A by PDCCH. Hereinafter, for the sake of convenience, the DCI for DL scheduling is called DL scheduling DCI. The terminal 20A that has received the DL scheduling DCI receives DL data by PDSCH using the resources specified in the DL scheduling DCI.

In step S302 and step S303, the terminal 20A transmits Sidelink Control Information (SCI) by PSCCH and/or PSSCH and SL data by PSSCH, using the resources specified in the SL scheduling DCI. Note that only the resources of PSSCH may be specified in the SL scheduling DCI. In this case, for example, the terminal 20A may transmit the PSCCH using a frequency resource adjacent to the frequency resource of the PSSCH in the same time resource as at least a part of the time resource of the PSSCH.

The terminal 20B receives the SCI (PSCCH and/or PSSCH) and SL data (PSSCH) transmitted from the terminal 20A. The SCI received by the PSCCH and/or PSSCH includes information of the resources of the PSECH for the terminal 20B to transmit an HARQ-ACK for receiving the data.

The information of the resource is included in the DL scheduling DCI or SL scheduling DCI transmitted from the base station 10 in step S301, and the terminal 20A acquires the information of the resource from the DL scheduling DCI or SI scheduling DCI and includes it in the SCI. Alternatively, the DCI transmitted from the base station 10 need not include information of the resource, and the terminal 20A may autonomously include information of the resource in the SCI and then transmit it.

In step S304, the terminal 20B transmits an HARQ-ACK for the received data to the terminal 20A using the resources of the PSFCH determined from the received SCI.

In step S305, the terminal 20A transmits an HARQ-ACK, for example, at the timing (for example, slot unit timing) specified by the DL scheduling DCI (or SL scheduling DCI) using the physical uplink control channel (PUCCH) resource specified by the DL scheduling DCI (or the SL scheduling DCI), and the base station 10 receives the HARQ-ACK. The codebook of the HARQ-ACK may include an HARQ-ACK generated on the basis of an HARQ-ACK received from the terminal 20B r a PSFCH not received, and an HARQ-ACK for DL data. However, when there is no DL data allocation and the like, the HARQ-ACK for DL data is not included. In NR Rel. 16, the codebook of the HARQ-ACK does not include the HARQ-ACK for DL data.

Note that, when the HARQ control with HARQ feedback is not performed, step S304 and/or step S305 need not be performed.

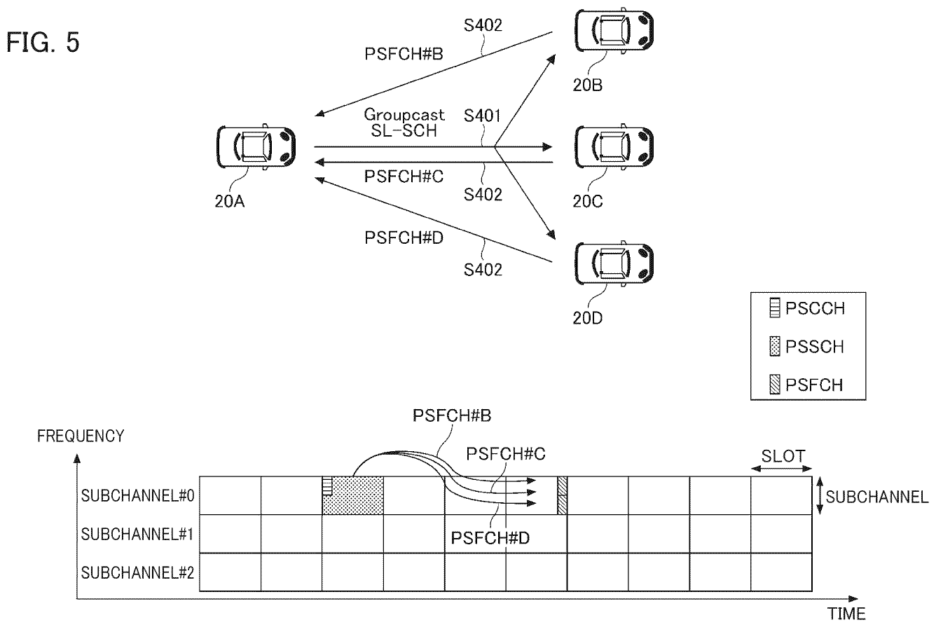

FIG. 5 is a sequence chart illustrating an example (4) of V2X operation. In the NR sidelink as described above, the transmission of an HARQ response is supported by PSFCH. Note that a PSFCH format that can be used is the same as, for example, physical uplink control channel (PUCCH) format 0. That is, the PSFCH format may be a sequence-based format where the Physical Resource Block (PRB) size is 1 and an ACK and a NACK are identified by sequence and/or cyclic shift differences. The PSFCH format is not limited to this. The PSFCH resources may be arranged in the last symbol or a plurality of symbols at the end of a slot. A period N is configured for the PSECH resource or is predefined. The period N may be configured or predefined in slot units.

In FIG. 5, the vertical axis corresponds to the frequency domain and the horizontal axis corresponds to the time domain. PSCCH may be arranged in one symbol at the beginning of a slot, in a plurality of symbols from the beginning, or in a plurality of symbols from a symbol other than the beginning. PSFCH may be arranged in one symbol at the end of the slot or in a plurality of symbols at the end of the slot. Note that, for the aforementioned “beginning of the slot” and “end of the slot”, consideration of symbols for Automatic Gain Control (AGC) and symbols for transmission/reception switching may be omitted. That is, for example, when one slot includes 14 symbols, “beginning of the slot” and “end of the slot” may mean that the first symbols and the end symbols from among the 12 symbols, excluding the first symbol and the last symbol. In an example illustrated in FIG. 5, three subchannels are configured in the resource pool, and two PSFCHs are arranged in the third slot after a slot in which the PSSCH is arranged. The arrows from PSSCH to PSECH show examples of PSFCHs associated with PSSCHs.

When an HARQ response in the NR-V2X groupcast is groupcast option 2 that transmits an ACK or NACK, it is necessary to determine the resources to be used for transmission and reception of PSFCH. As illustrated in FIG. 5, in step S401, the terminal 20A which is a transmission-side terminal 20, performs groupcast to terminals 20B, 20C, and 20D, which are reception-side terminals 20, via a sidelink shared channel (SL-SCH). In subsequent step S402, the terminal 20B uses PSFCH #B, the terminal 20C uses PSFCH #C, and the terminal 20D uses PSFCH #D to transmit the HARQ response to the terminal 20A. Here, as illustrated in the example in FIG. 5, when the number of available PSFCH resources is less than the number of reception-side terminals 20 belonging to the group, it is necessary to determine how to allocate the PSFCH resources. Note that the transmission-side terminal 20 may be aware of the number of reception-side terminals 20 in groupcast. Note that, in Groupcast Option 1, only a NACK is transmitted as an HARQ response, and an ACK is not transmitted.

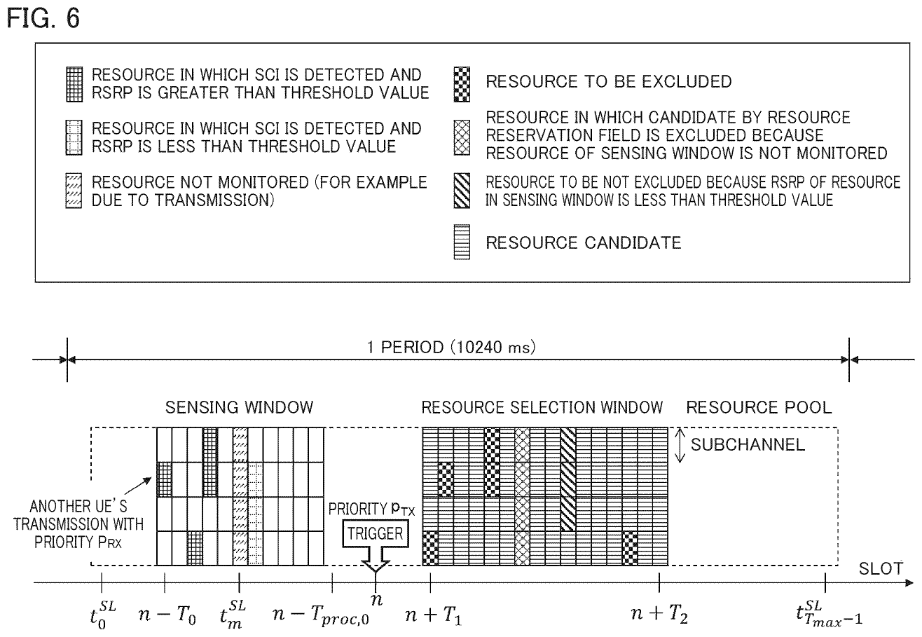

FIG. 6 is a diagram illustrating an example of a sensing operation in NR. In resource allocation mode 2, the terminal 20 selects resources and transmits them. As illustrated in FIG. 6, the terminal 20 performs sensing in a sensing window in a resource pool. Sensing enables the terminal 20 to receive a resource reservation field or resource assignment field included in SCI transmitted from another terminal 20 and to identify available resource candidates in a resource selection window in the resource pool on the basis of the received field. Subsequently, the terminal 20 randomly selects resources from the available resource candidates.

As illustrated in FIG. 6, the resource pool configurations may have a period. For example, the period may be 10240 milliseconds. FIG. 6 illustrates an example of configuring slot t₀^{SL} to slot t_{Tmax-1}^{SL} as a resource pool. Areas may be configured in the resource pool within the period, by means of, for example, a bitmap.

As illustrated in FIG. 6, a transmission trigger at the terminal 20 occurs in slot n, and the priority of the transmission is p_{TX}. The terminal 20 can detect, for example, that another terminal 20 is performing transmission with priority p_{RX} in the sensing window from slot n-T₀ to a slot immediately before slot n-T_{proc,0}. When SCI is detected in the sensing window and the reference signal received power (RSRP) is greater than a threshold value, the resource in the resource selection window corresponding to the SCI is excluded. When SCI is detected in the sensing window and the RSRP is less than the threshold value, the resource in the resource selection window corresponding to the SCI is not excluded. The threshold value may be, for example, the threshold value Th_{pTX,pRX} configured or defined for each resource in the sensing window on the basis of the priority p_{TX} and the priority p_{RX}.

The resources in the resource selection window that serve as candidates for resource reservation information, corresponding to the resources in the sensing window that are unmonitored, for example, due to transmission, are excluded, as in the slot tₘ^{SL} illustrated in FIG. 6.

In the resource selection window from slot n+T₁ to slot n+T₂, as illustrated in FIG. 6, the resources occupied by another UE are identified and the resources excluding such resources serve as available resource candidates. When the set of available resource candidates is S_{A} and S_{A} is less than 20% of the resource selection window, the resources may be identified again by increasing the threshold value Th_{pTX,pRX} configured for each resource in the sensing window by 3 dB. That is, by increasing the threshold value Th_{pTX,pRX} and identifying the resource again, the resources, which are not excluded because their RSRP is less than the threshold value, may be increased, and the set S_{A} of resource candidates may be 20% or more of the resource selection window. When the S_{A} is less than 20% of the resource selection window, the operation of increasing the threshold value Th_{pTX,pRX} configured for each resource in the sensing window by 3 dB and identifying the resource again may be repeated.

A lower layer of the terminal 20 may report the S_{A} to a higher layer. The higher layer of the terminal 20 may perform random selection with respect to the S_{A} to determine resources to be used. The terminal 20 may perform sidelink transmission using the determined resources. For example, the higher layer may be a MAC layer, and the lower layer may be a PHY layer or a physical layer.

Although the operation of the transmission-side terminal 20 has been described in FIG. 6 described above, the reception-side terminals 20 may detect the data transmission from other terminals 20 on the basis of the results of sensing or partial sensing, and receive data from the other terminals 20.

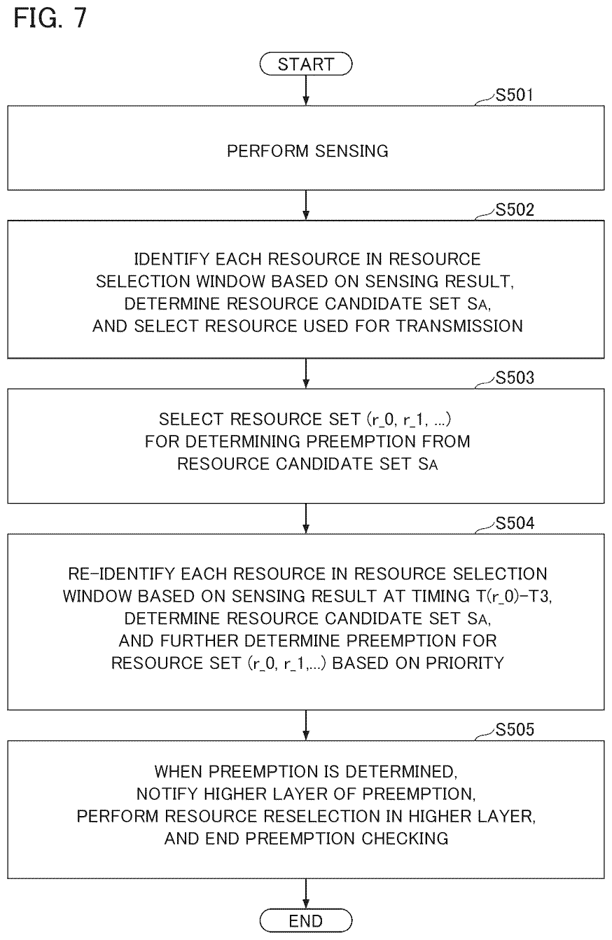

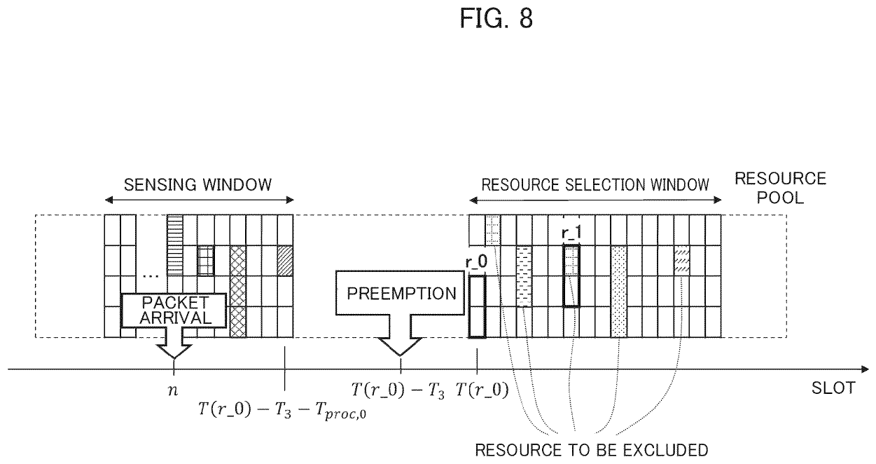

FIG. 7 is a flowchart illustrating an example of preemption in NR. FIG. 8 is a diagram illustrating an example of preemption in NR. In step S501, the terminal 20 performs sensing in a sensing window. When the terminal 20 performs a power saving operation, the sensing may be performed for a predefined, limited period of time. Subsequently, the terminal 20 identifies each resource in a resource selection window on the basis of the sensing results to determine a set SA of resource candidates, and selects resources to be used for transmission (S502). Subsequently, the terminal 20 selects a resource set (r_0, r_1, . . . ) for which preemption is determined from the set SA of resource candidates (S503). The resource set may be notified from the higher layer to the PHY layer as a resource for determining whether or not preemption has occurred.

In step S504, the terminal 20 re-identifies each resource in the resource selection window on the basis of the sensing results at the timing of T(r_0)-T₃ illustrated in FIG. 8 to determine the set SA of resource candidates, and further determines preemption for the resource set (r_0, r_1, . . . ) on the basis of the priority. For example, r_1 illustrated in FIG. 8, is not included in SA because the SCI transmitted from another terminal 20 is detected through sensing again. When the preemption is enabled, the terminal 20 determines that resource r_1 has been preempted in a case where a value prio_RX indicating the priority of the SCI transmitted from the other terminal 20 is lower than a value prio_TX indicating the priority of the transport block transmitted from the own terminal. Note that the lower the value indicating the priority, the higher the priority. That is, when the value prio_RX indicating the priority of the SCI transmitted from the other terminal 20 is higher than the value prio_TX indicating the priority of the transport block transmitted from the own terminal, the terminal 20 does not exclude resource r_1 from the SA. Alternatively, when the preemption is enabled only for a specific priority (for example, sl-PreemptionEnable is any of pl1, pl2, . . . , pl8), this priority is taken as prio_pre. At this time, when the value prio_RX indicating the priority of the SCI transmitted from the other terminal 20 is lower than prio_pre and prio_RX is lower than the value prio_TX indicating the priority of the transport block transmitted from the own terminal, the terminal 20 determines that resource r_1 has been preempted.

In step S505, when the preemption is determined in step S504, the terminal 20 notifies the higher layer of the preemption, performs resource reselection in the higher layer, and ends the preemption checking.

Note that, when re-evaluation is performed instead of preemption checking, in step S504 described above, after the set SA of resource candidates is determined, in a case where resources of the resource set (r_0, r_1, . . . ) are not included in Sa, reselection of resources is performed in an higher layer without using the resources.

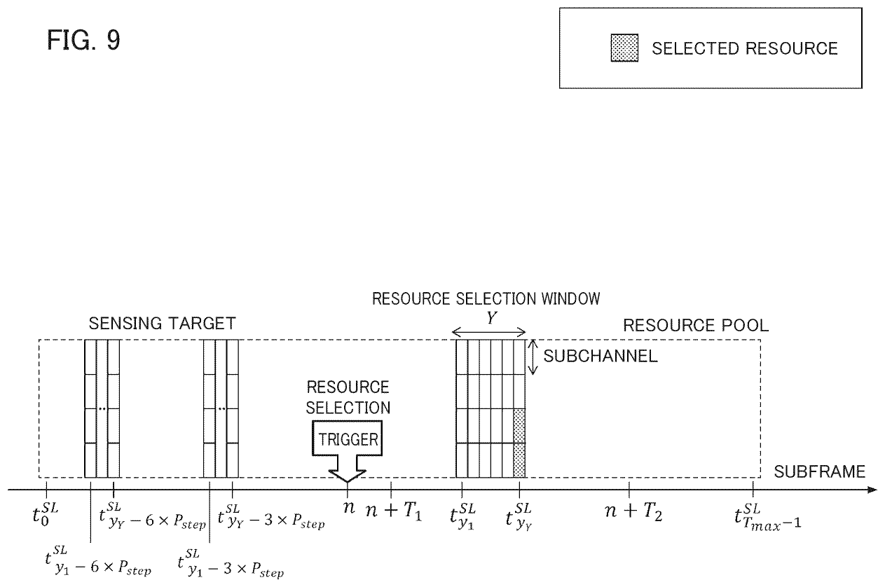

FIG. 9 is a diagram illustrating an example of a partial sensing operation in LTE. When the partial sensing is configured by a higher layer in the LTE sidelink, the terminal 20 selects resources and transmits them as illustrated in FIG. 9. As illustrated in FIG. 9, the terminal 20 performs partial sensing for a portion of the sensing window in the resource pool, that is, a sensing target. Partial sensing enables the terminal 20 to receive a resource reservation field included in the SCI transmitted from another terminal 20 and to identify available resource candidates in a resource selection window in the resource pool on the basis of the received field. Subsequently, the terminal 20 randomly selects resources from the available resource candidates.

FIG. 9 illustrates an example in which subframes from subframe t₀^{SL} to subframe t_{Tmax-1}^{SL} are configured as a resource pool. Target areas may be configured in the resource pool by means of, for example, a bitmap. As illustrated in FIG. 9, a transmission trigger at the terminal 20 occurs in subframe n. As illustrated in FIG. 9, among the subframes from subframe n+T₁ to subframe n+T₂, Y subframes from subframe t_{y1}^{SL} to subframe t_{yY}^{SL} may be configured as a resource selection window.

The terminal 20 can detect, for example, that another terminal 20 performs transmission in one or more sensing targets from subframe t_{y1-k×Pstep}^{SL} to subframe t_{yY-k×Pstep}^{SL}, which is Y subframes in length. k may be determined by, for example, a 10-bit bitmap. FIG. 9 illustrates an example of configuring the third and sixth bits of a bitmap to “1” indicating that partial sensing is to be performed. That is, in FIG. 9, subframe t_{y1-6×Pstep}^{SL} to subframe t_{yY-6×Pstep}^{SL} and subframe t_{y1-3×Pstep}^{SL} to subframe t_{yY-3×Pstep}^{SL} are configured as sensing targets. As described above, the k-th bit of the bitmap may correspond to the sensing window from subframe t_{y1-k×Pstep}^{SL} to subframe t_{yY-k×Pstep}^{SL}. Note that yᵢ corresponds to an index (1 . . . Y) in the Y subframes.

Note that k is configured or predefined in a 10-bit bitmap, and Pₛₜₑₚ may be 100 ms. However, in the case of performing SL communication on DL and UL carriers, Pₛₜₑₚ may be (U/(D+S+U))*100 ms. U corresponds to the number of UL subframes, D corresponds to the number of DL subframes, and S corresponds to the number of special subframes.

When an SCI is detected in the above sensing target and the RSRP is greater than the threshold value, the resource in the resource selection window corresponding to the resource reservation field of the SCI is excluded. When an SCI is detected in the sensing target and the RSRP is less than the threshold value, the resource in the resource selection window corresponding to the resource reservation field of the SCI is not excluded. The threshold value may be, for example, the threshold value Th_{pTX,pRX} configured or defined for each resource in the sensing target on the basis of the transmission-side priority p_{TX} and the reception-side priority P_{RX}.

As illustrated in FIG. 9, in a resource selection window configured in the Y subframes in the section [n+T₁, n+T₂], the terminal 20 identifies a resource occupied by another UE, and the resource excluding the identified resource becomes available resource candidates. Note that the Y subframes need not be contiguous. When the set of available resource candidates is SA and Sa is less than 20% of the resources in the resource selection window, the resources may be identified again by increasing the threshold value Th_{pTX,pRX} configured for each resource in the sensing target by 3 dB.

That is, by increasing the threshold value Th_{pTX,pRX} and identifying the resource again, the resources, which are not excluded because their RSRP is less than the threshold value, may be increased. The RSSI of each resource in the SA may be measured and the resource with the lowest RSSI may be added to the set SB. The operation of adding the resource with the lowest RSSI included in the SA to the SB may be repeated until the set SB of resource candidates becomes 20% or more of the resource selection window.

The lower layer of the terminal 20 may report the SB to the higher layer. The higher layer of the terminal 20 may perform random selection with respect to the SB to determine resources to be used. The terminal 20 may perform sidelink transmission using the determined resources. Note that the terminal 20 may periodically use the resource without performing sensing a predetermined number of times (for example, Cᵣₑₛₑₜ times) after securing the resource once.

In the NR sidelink, power saving based on random resource selection and partial sensing is specified. The terminal 20 to which partial sensing is applied performs reception and sensing only in a specific slot in the sensing window. That is, the terminal 20 may perform partial sensing in which resource identification is performed by sensing only limited resources as compared to full sensing and resource selection from the identified resource set is performed. The terminal 20 may, without excluding resources from the resources in the resource selection window, cause the resources in the resource selection window to be an identified resource set and may perform random selection to Select a resource from the identified resource set.

Note that the method of performing random selection at the time of resource selection and using sensing information at the time of re-evaluation or preemption checking may be treated as partial sensing or as random selection.

The following 1) and 2) may be applied as operations in sensing. Note that the sensing and monitoring may be read interchangeably, and at least one of measurement of received RSRP, acquisition of reserved resource information, and acquisition of priority information may be included in the operation.

### 1) Periodic-Based Partial Sensing

Operation of determining a sensing slot on the basis of reservation periodicity in a mechanism in which sensing is performed only for some slots. Note that the reservation period is a value related to the resource reservation period field. Note that the period may be replaced by the periodicity.

### 2) Contiguous Partial Sensing

Operation of determining a sensing slot on the basis of aperiodic reservation in a mechanism in which sensing is performed only for some slots. Note that the aperiodic reservation is a value related to the time resource assignment field.

Multiple resource allocation methods can be configured for a certain resource pool. SL-DRX (Discontinuous reception) is supported as one of the power saving functions. That is, the reception operation is performed only for a predetermined time section.

As described above, partial sensing is supported as one of the power saving functions. In a resource pool in which partial sensing is configured, the terminal 20 may perform the periodic-based partial sensing described above. The terminal 20 may receive, from the base station 10, information for configuring a resource pool in which partial sensing is configured and periodic reservation is configured to be enabled.

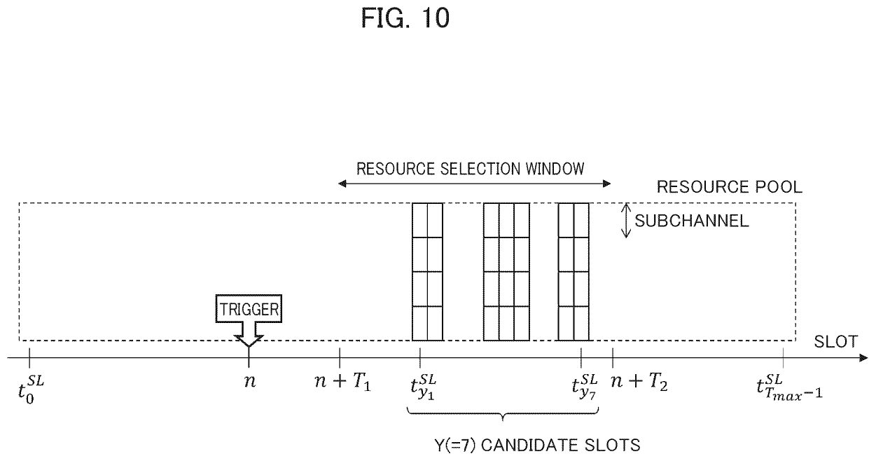

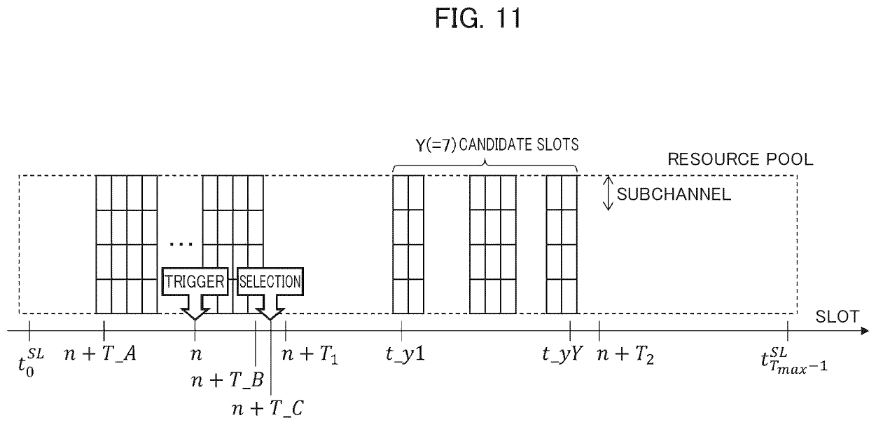

FIG. 10 is a diagram for explaining an example of periodic-based partial sensing. As illustrated in FIG. 10, Y candidate slots for resource selection are selected from a resource selection window [n+T₁, n+T₂].

Assuming that t_{y}^{SL} is a slot included in the Y candidate slots, sensing may be performed by having t_{y-k*Preserve}^{SL} as a target slot of the periodic-based partial sensing.

Pᵣₑₛₑᵣᵥₑ may correspond to all values included in the set sl-ResouceReservePeriodList that is configured or predefined. Alternatively, the value of Pᵣₑₛₑᵣᵥₑ that is limited to a subset of sl-ResouceReservePeriodList may be configured or predefined. The Pᵣₑₛₑᵣᵥₑ and sl-ResouceReservePeriodList may be configured for each transmission resource pool of the resource allocation mode 2. As an UE implementation, a period included in sl-ResouceReservePeriodList other than the limited subset may be monitored. For example, the terminal 20 may additionally monitor an occasion corresponding to P_RSVP_Tx.

Regarding the k value, the terminal 20 may monitor the latest sensing occasion in a reservation period before slot n of the resource selection trigger or before the first slot of the Y candidate slots subject to a processing time limitation. The terminal 20 may additionally monitor a periodic sensing occasion corresponding to a set of one or more k values. For example, as the k value, a value corresponding to the latest sensing occasion in a certain reservation period before slot n of the resource selection trigger or before the first slot of the Y candidate slots subject to the processing time limitation, and a value corresponding to the sensing occasion immediately before the latest sensing occasion in the certain reservation period may be configured.

As described above, partial sensing is supported as one of the power saving functions. In a resource pool in which partial sensing is configured, the terminal 20 may perform the contiguous partial sensing described above. The terminal 20 may receive, from the base station 10, information for configuring a resource pool in which partial sensing is configured and aperiodic reservation is configured to be enabled.

FIG. 11 is diagram for explaining an example of contiguous partial sensing. As illustrated in FIG. 11, when the trigger for resource selection is denoted as slot n, the terminal 20 selects Y candidate slots for resource selection from a resource selection window [n+T₁, n+T₂]. FIG. 11 is an example for the case of Y=7. As illustrated in FIG. 11, the beginning of the Y candidate slots is denoted as slot t_{y1}, the subsequent slot is denoted as t_{y2}, . . . , and the end of the Y candidate slots is denoted as slot t_{yY}.

The terminal 20 performs sensing in the section [n+T_{A}, n+T_{B}] and performs resource selection at n+T_{B} or after n+T_{B} (referred to as n+T_{C}). Note that the periodic-based partial sensing described above may be additionally performed. Note that T_{A} and T_{B} of the section [n+T_{A}, n+T_{B}] may be any value. n may be replaced with an index of a slot from among Y candidate slots.

The mark “[” may be replaced with the mark “(”, and the mark “]” may be replaced with the mark “)”. Note that, for example, the section [a, b] is a section from slot a to slot b, and includes the slot a and the slot b. For example, the section (a, b) is a section from slot a to slot b, and does not include the slot a and the slot b.

Note that candidate resources that are targets of resource selection are described as Y candidate slots, and all slots or some slots in the section [n+T₁, n+T₂] may be candidate slots.

Inter-terminal coordination is specified as a method for improving reliability and delay performance. For example, an inter-terminal coordination method 1 and an inter-terminal coordination method 2 described below are specified. Hereinafter, the terminal 20 that transmits the coordination information is referred to as UE-A, and the terminal 20 that receives the coordination information is referred to as UE-B.

### Inter-Terminal Coordination Method 1

A preferred resource set and/or a non-preferred resource set for transmission of the UE-B is transmitted from the UE-A to the UE-B. Hereinafter, the inter-terminal coordination method 1 is also described as an IUC scheme 1(inter-UE coordination scheme 1).

### Inter-Terminal Coordination Method 2

In a resource indicated by SCI that is received from the UE-B, the UE-A transmits, to the UE-B, information indicating an expectation of a collision with another transmission or reception and/or a resource in which the collision is detected. The information may be transmitted via the PSFCH. Hereinafter, the inter-terminal coordination method 2 is also described as an IUC scheme 2 (inter-UE coordination scheme 2).

With respect to the 3GPP release 16 or release 17 sidelink, specifications are being developed targeting 1) and 2) below.

1) Environment in the Intelligent Transport Systems (ITS) band in which there are only 3GPP terminals

2) Environment in the frequency range 1 (FR1) and FR2 licensed band defined in NR in which UL resources can be used for SL

Discussions are being performed in which an unlicensed band is newly targeted as the sidelink of 3GPP release 18 and later. For example, an unlicensed band such as the 5 GHz to 7 GHz band, 60 GHz band, or the like.

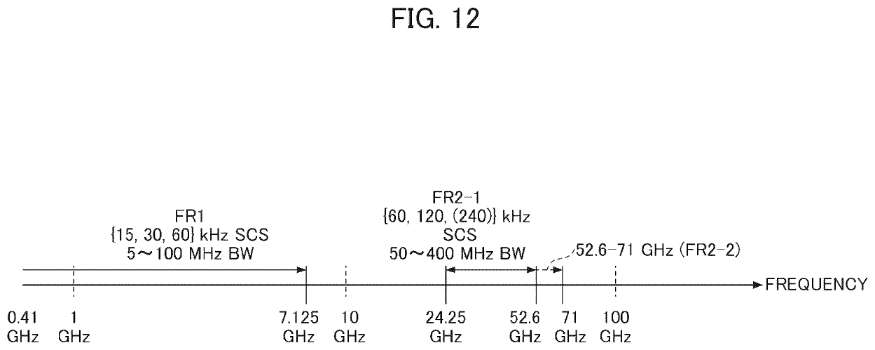

FIG. 12 is a diagram illustrating an example of a frequency band used in a radio communication system. In the 3GPP release 15 and release 16 NR specifications, for example, an operation of a frequency band of 52.6 GHz or more is being discussed. Note that, as illustrated in FIG. 12, the frequency range (FR) 1 in which the current operation is specified is a frequency band from 410 MHz to 7.125 GHz, the sub carrier spacing (SCS) is 15, 30, or 60 kHz, and the bandwidth is from 5 MHz to 100 MHz.

FR2-1 is a frequency band from 24.25 GHz to 52.6 GHz, the SCS uses 60, 120, or 240 KHz, and the bandwidth is from 50 MHz to 400 MHz. As illustrated in FIG. 12, FR2-2 may be assumed to be from 52.6 GHz to 71 GHz. It may be assumed to support a frequency band exceeding 71 GHz.

When a band exceeding 52.6 GHz is used, Cyclic Prefix-Orthogonal Frequency Division Multiplexing (CP-OFDM)/Discrete Fourier Transform-Spread (DFT-S-OFDM) having larger sub-carrier spacing (SCS) may be applied.

In a high frequency band such as FR2-2, an increase in phase noise between carriers becomes a problem. For this reason, application of a larger (wider) SCS or single carrier waveform may be required.

For example, a band from 5.15 GHz to 5.35 GHz, a band from 5.47 GHz to 5.725 GHz, a band of 5.925 GHz or more, or the like is expected as an example of an unlicensed band in the 5 GHz to 7 GHz band.

For example, a band from 59 GHz to 66 GHz, a band from 57 GHz to 64 GHz or 66 GHz, a band from 59.4 GHz to 62.9 GHz, or the like is expected as an example of an unlicensed band in the 60 GHz band.

In the unlicensed band, various regulations are specified so as to avoid influence to another system or another device.

For example, in the 5 GHz to 7 GHz band, a Listen Before Talk (LBT) is performed when accessing a channel. The base station 10 or the terminal 20 performs power detection in a predetermined time period immediately before transmission, and stops the transmission when the power exceeds a certain value, that is, when transmission from another device is detected (which may called failed LBT). The maximum channel occupancy time (MCOT) is specified. The MCOT is a maximum time duration in which transmission continuation is allowed when transmission is started after the LBT, and is 4 ms in Japan, for example.

When the transmission uses a carrier bandwidth, X% or more of the bandwidth has to be used as the occupied channel bandwidth (OCB) requirements. For example, in Europe, as much as 80% to 100% of the nominal channel bandwidth (NCB) is required to be used. The purpose of the OCB requirements is that the channel access power detection is to be performed correctly.

In order to avoid excessive interference with respect to the maximum transmission power and the maximum power spectral density, it is specified that the transmission is to be performed with predetermined transmission power or less. For example, in Europe, the maximum transmission power is 23 dBm in the 5150 MHz to 5350 MHz band. For example, in Europe, the maximum power spectral density is 10 dBm/MHz in the 5150 MHz to 5350 MHz band.

For example, in the 60 GHz band, an LBT is performed when accessing a channel. The base station 10 or the terminal 20 performs power detection in a predetermined time period immediately before transmission, and stops the transmission when the power exceeds a certain value, that is, when transmission from another device is detected. With respect to the maximum transmission power and the maximum power spectral density, it is specified that the transmission is to be performed with predetermined transmission power or less. It is also specified to have the ability to meet OCB requirements.

In the NR, four types of channel access procedures described below are defined on the basis of a difference in behavior in the time direction of the LBT (period in which sensing is performed). Note that the sensing is an operation different from the sidelink sensing described above, and is described as LBT sensing for distinction.

Type 1) Variable time LBT sensing is performed before transmission. It is also called category 4LBT.

Type 2A) LBT sensing of 25 μs is performed before transmission. It is also called category 2LBT.

Type 2B) LBT sensing of 16 μs is performed before transmission. It is also called category 2LBT.

Type 2C) Transmission is started without LBT. Similar to transmission of a license band.

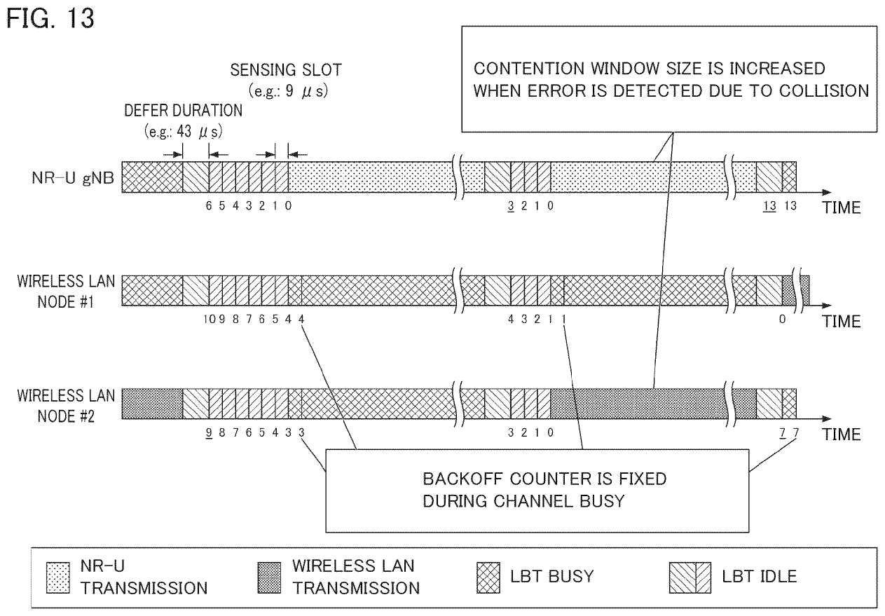

FIG. 13 is a diagram for explaining an example (1) of LBT. FIG. 13 is an example of channel access procedures of Type 1. Type 1 is further classified into four classes indicating a channel access priority class (CAPC) on the basis of a difference in LBT sensing length. LBT sensing is performed in the following two periods.

The first period is a prioritization period or a defer duration and has a length of 16+9×mₚ [μs]. A fixed value of mₚ is defined for each channel access priority class.

The second period is a backoff procedure and has a length of 9×N [μs]. The value of N is randomly determined from a certain range (see the CWS adjustment procedure of Non Patent Literature 4). N is an initial value of the backoff counter, and the value of the backoff counter decreases by 1 every time the power of the signal of the other device is not detected during 9 [μs].

In the above description, the LBT sensing period of 9 μs may be referred to as an LBT sensing slot period.

In the example of FIG. 13, mₚ=3, and the defer duration is 43 μs. As illustrated in FIG. 13, the backoff counter is fixed during channel busy. As illustrated in FIG. 13, when the transmission of the NR-U gNB and the transmission of the wireless LAN node #2 collide with each other and an error is detected, the contention window size (CWS) is increased from 3 to 13 in the NR-U qNB.

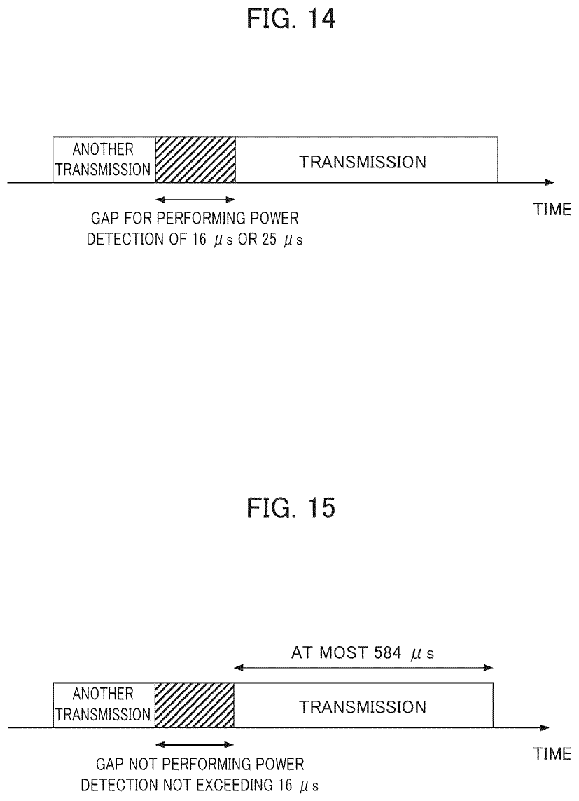

FIG. 14 is a diagram for explaining an example (2) of LBT. FIG. 14 is an example of channel access procedures of Type 2A or Type 2B without random backoff. A gap for performing power detection of 25 μs or more than 25 μs for Type 2A or 16 μs for Type 2B is configured before transmission.

FIG. 15 is a diagram for explaining an example (3) of LBT. FIG. 15 is an example of channel access procedures of Type 2C. As illustrated in FIG. 15, the power detection is not performed before transmission, and after a gap not exceeding 16 μs, transmission is performed immediately. The transmission period may be up to 584 μs.

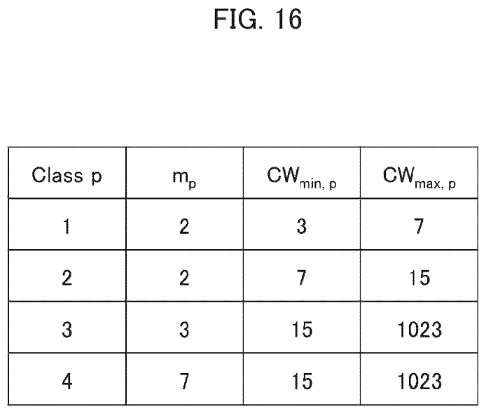

As described above, a plurality of LBT types is supported in the NR-U. In Type 1 described above, as the initial value N of the backoff counter, a random number of sections from 0 to CWₚ whose value range is determined on the basis of the channel access priority class p is configured. FIG. 16 illustrates an example of mp defined for each channel access priority class p in the UL, minimum value CW_{p,min} of CWₚ, and maximum value CW_{p,max} of CWₚ.

As illustrated in FIG. 16, mp, CW_{p,min}, and CW_{p,max} are determined by the channel access priority class p. When p is 1, the LBT period is calculated from Table 1 to be at least 34 μs and at most 88 μs. When p is 2, the LBT period is calculated from Table 1 to be at least 34 μs and at most 160 μs. When p is 3, the LBT period is calculated from Table 1 to be at least 43 μs and at most 9286 μs. When p is 4, the LBT period is calculated from Table 1 to be at least 79 us and at most 9286 μs. Note that Table 1 is a table used for UL.

The LBT type and the channel access priority class may be determined on the basis of a notification from the base station 10, a channel type, or the like. A gap of 25 μs or 16 μs may be configured in consideration of timing advance (TA) and CP extension by scheduling of the base station 10.

The LBT applied to the channel access is performed for each predetermined bandwidth (for example, 20 MHz). This may be referred to as an LBT channel, an RB set, or an LBT band, and is not limited thereto. When no power is detected in the LBT channel in which each transmission is included, transmission can be performed. Meanwhile, each CC in Uu may be defined with a wider bandwidth than the LBT channel. That is, the wideband operation is supported. Note that Uu is a radio interface between Universal Terrestrial Radio Access Network (UTRAN) and User Equipment (UE).

### Problem

Under the above-described circumstances, since it is assumed that the transmission of PSFCH is not performed due to a factor such as LBT failure, it has been discussed to enable the transmission period of PSFCH (PSFCH occasion) to be used twice or more for a certain PSCCH/PSSCH.

Under such circumstances, as a result of intensive studies, the inventors have found a need to clarify a procedure related to transmission of a sidelink channel (PSCCH/PSSCH/PSFCH) in a case where two or more PSFCH occasions can be used for a certain PSCCH/PSSCH.

### Operation Example

In order to solve the above problem, the terminal 20 may perform the following operation.

Specifically, the terminal 20 performs communication of sidelink channel (PSCCH/PSSCH/PSFCH) and controls communication of sidelink channel (PSCCH/PSSCH/PSFCH). The terminal 20 controls transmission of the sidelink channel by a specific method when two or more transmission occasions (PSECH occasions) are usable as a transmission occasion of a sidelink feedback channel (PSFCH) transmitting a feedback.

As illustrated in FIG. 5 described above, the feedback may include an HARQ response. The feedback may include information corresponding to IUC Scheme 2 described above. The PSFCH may be used as a term indicating feedback.

The specific method may be different for PSFCH (for example, first PSFCH) for transmitting an HARQ response and PSFCH (for example, second PSFCH) for transmitting information corresponding to IUC Scheme 2.

### Operation Example 1

In Operation Example 1, as a specific method, the terminal 20 determines at least one resource of a sidelink control channel (PSCCH) and a sidelink shared channel (PSSCH) on the basis of two or more transmission occasions (PSFCH occasions). As options of Operation Example 1, the following options are conceivable.

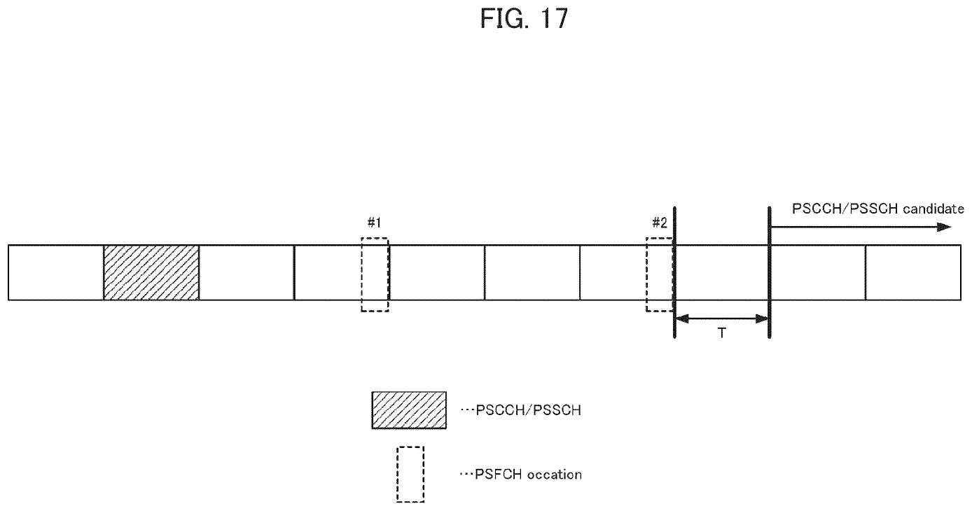

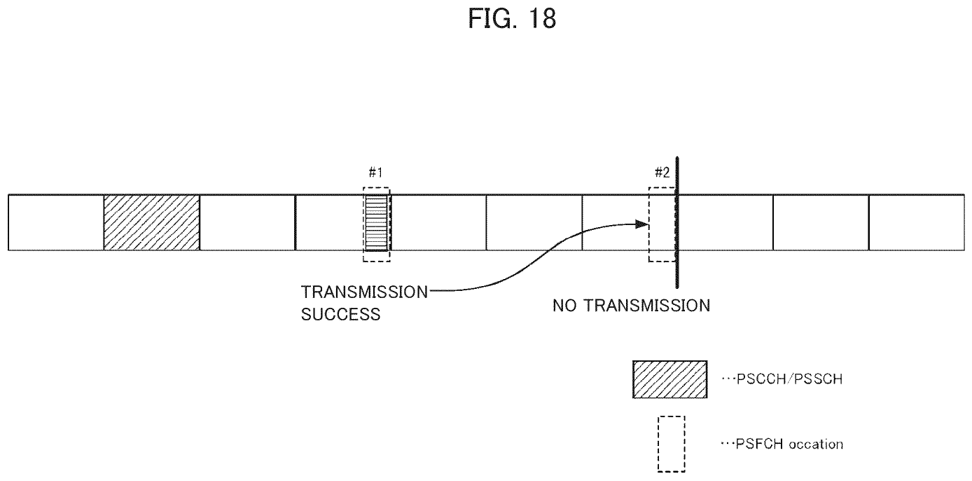

In Option 1-1, the terminal 20 that transmits the PSCCH/PSSCH determines to use the resource of PSCCH/PSSCH after the last PSFCH occasion in the two or more PSFCH occasions in retransmission. For example, as illustrated in FIG. 17, when the last PSFCH occasion is PSFCH occasion #2, the resource of PSCCH/PSSCH may be a resource after T elapses from PSFCH occasion #2. T may be defined in us, or may be defined in symbol, sub-slot, or slot. T may be predefined in the radio communication system, or may be configured by an RRC parameter.

In Option 1-1, a PSFCH (first PSFCH) for transmitting an HARQ response may be assumed as the PSFCH. The terminal 20 that transmits the PSCCH/PSSCH may be replaced with the terminal 20 that receives the first PSFCH.

In Option 1-2, the terminal 20 that transmits the PSCCH/PSSCH determines to use the resource of PSCCH/PSSCH after a specific PSFCH occasion in the two or more PSFCH occasions in retransmission. For example, as illustrated in FIG. 17, when the specific PSFCH occasion is PSFCH occasion #2, the resource of PSCCH/PSSCH may be a resource after T elapses from PSFCH occasion #2. Alternatively, when the specific PSFCH occasion is PSFCH occasion #1, the resource of PSCCH/PSSCH may be a resource after T elapses from PSFCH occasion #1. T may be defined in us, or may be defined in symbol, sub-slot, or slot. T may be predefined in the radio communication system, or may be configured by an RRC parameter.

In Option 1-2, the specific PSFCH occasion may be predefined in the radio communication system, or may be configured by an RRC parameter.

In Option 1-2, a PSFCH (first PSFCH) for transmitting an HARQ response may be assumed as the PSFCH. The terminal 20 that transmits the PSCCH/PSSCH may be replaced with the terminal 20 that receives the first PSFCH.

In Option 1-3, the terminal 20 that transmits the PSCCH/PSSCH may not perform the retransmission of PSCCH/PSSCH when receiving a positive HARQ response (ACK) in the PSFCH occasion that is prior to the resource of PSCCH/PSSCH for the retransmission only by T′. Note that, in the case of the groupcast, conditions may be different. For example, in Groupcast Option 1 (NACK-only feedback), “when a positive HARQ response (ACK) is received” may be replaced with “when a negative HARQ response (NACK) is not detected”, and in Groupcast Option 2 (ACK/NACK feedback), “when a positive HARQ response (ACK) is received” may be replaced with “when a positive HARQ response (ACK) is received from all the terminals 20 that receive the groupcast”. T′ may be defined in us, or may be defined in symbol, sub-slot, or slot. T′ may be predefined in the radio communication system, or may be configured by an RRC parameter.

In Option 1-3, a PSFCH (first PSFCH) for transmitting an HARQ response may be assumed as the PSFCH. The terminal 20 that transmits the PSCCH/PSSCH may be replaced with the terminal 20 that receives the first PSFCH.

In Option 1-4, the terminal 20 that transmits the PSCCH/PSSCH may perform the reselection of the resource of PSCCH/PSSCH without using the resource of the reserved PSCCH/PSSCH when receiving conflict indication in the PSFCH occasion that is prior to the resource of the reserved PSCCH/PSSCH only by T′. T′ may be defined in us, or may be defined in symbol, sub-slot, or slot. T′ may be predefined in the radio communication system, or may be configured by an RRC parameter.

In Option 1-4, a PSFCH (second PSFCH) for transmitting information corresponding to IUC Scheme 2 may be assumed as the PSFCH. The terminal 20 that transmits the PSCCH/PSSCH may be replaced with the terminal 20 that receives the second PSFCH.

Note that the conflict indication may be information indicating an expectation of a collision with another transmission or reception and/or a resource in which the collision is detected in a resource indicated by SCI (PSCCH/PSSCH) transmitted from the terminal 20 that transmits the PSCCH/PSSCH.

According to Operation Example 1, since the resource of PSCCH/PSSCH is determined on the basis of the two or more PSFCH occasions, it is possible to clarify the timeline between the PSSCH/PSFCH and the PSFCH and to suppress useless transmission/retransmission of the PSCCH/PSSCH.

### Operation Example 2

In Operation Example 2, the terminal 20 transmits a sidelink feedback channel (PSFCH) in a specific occasion selected from transmission occasions of two or more transmission occasions (PSFCH occasions) as a specific method. As options of Operation Example 2, the following options are conceivable. Note that different options may be applied depending on the cast type and feedback method. For example, common options may be applied among unicast, Groupcast Option 1 (NACK-only feedback), and Groupcast Option 2 (ACK/NACK feedback), and different options may be applied.

In Option 2-1, the terminal 20 that transmits the PSFCH may select the temporally earliest PSFCH occasion as a specific occasion. When the terminal 20 that transmits the PSFCH can transmit the PSFCH, the terminal 20 does not need to transmit the PSFCH in the subsequent PSFCH occasion (may cancel the PSFCH). When the terminal 20 that transmits the PSFCH cannot transmit the PSFCH, the terminal 20 may reselect the temporally earliest PSFCH occasion at that time as a specific occasion. The terminal 20 that transmits the PSFCH may repeat such an operation for all the PSFCH occasions.

For example, as illustrated in FIG. 18, when PSFCH occasion #1 and PSFCH occasion #2 are usable, the terminal 20 does not need to transmit the PSFCH in PSFCH occasion #2 in a case where PSFCH can be transmitted in PSFCH occasion #1.

In Option 2-1, the cause for not being able to transmit the PSFCH may include LBT failure and may be limited to LBT failure. The cause that the PSFCH cannot be transmitted may include other causes (for example, prioritization, half-duplex, and the like).

In Option 2-2, the terminal 20 that transmits the PSFCH may select all the PSFCH occasions as a specific occasion. That is, the terminal 20 that transmits the PSFCH may transmit the PSECH in all the two or more PSFCH occasions. In such a case, whether or not the PSFCH has been transmitted may not be considered.

In Option 2-3, when the terminal 20 that transmits the PSFCH receives the retransmitted PSCCH/PSSCH by timing prior to the #n-th PSFCH occasion only by T″, the terminal 20 does not need to transmit the PSFCH in the #n-th PSFCH occasion (may cancel the PSFCH). T″ may be defined in us, or may be defined in symbol, sub-slot, or slot. T″ may be predefined in the radio communication system, or may be configured by an RRC parameter.

In Option 2-3, a PSFCH (first PSFCH) for transmitting an HARQ response may be assumed as the PSFCH. The terminal 20 that transmits the PSFCH may be replaced with the terminal 20 that receives the PSCCH/PSSCH.

In Option 2-3, even when the terminal 20 that transmits the PSFCH cannot transmit the PSFCH in the PSFCH occasion before the #n-th PSECH occasion, the terminal 20 does not need to transmit the PSFCH in the #n-th PSFCH occasion.

In Option 2-3, the terminal 20 that transmits the PSFCH may transmit the PSFCH to the retransmitted PSCCH/PSSCH.

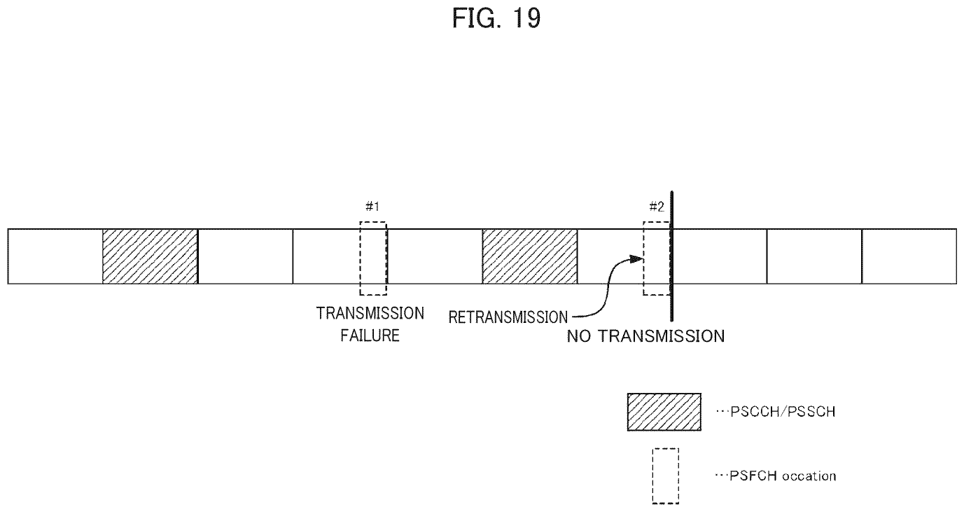

For example, as illustrated in FIG. 19, when PSFCH occasion #1 and PSFCH occasion #2 are usable, the terminal 20 does not need to transmit the PSFCH in PSFCH occasion #2 in a case where the retransmitted PSCCH/PSSCH is received before PSFCH occasion #2.

According to Operation Example 2, when the two or more PSFCH occasions are usable, the operation of the terminal 20 that transmits the PSFCH is clarified.

### Functions and Effects

In the embodiment, the terminal 20 controls transmission of the sidelink channel by a specific method when two or more transmission occasions (PSFCH occasions) are usable as a transmission occasion of a sidelink feedback channel (PSFCH) transmitting a feedback. According to such a configuration, in a case where two or more PSFCH occasions are usable for a certain PSCCH/PSSCH, a sidelink channel (PSCCH/PSSCH/PSFCH) can be appropriately transmitted.

### Other Embodiments

Although the contents of the present invention have been described above according to the embodiments, the present invention is not limited to these descriptions, and it is obvious to those skilled in the art that various modifications and improvements can be made.

In the above-described disclosure, the configurations of the SL channel and the SL signal of the related art are used, but the present invention is not limited thereto. For example, even when an interlaced channel is applied as a configuration for satisfying the OCB requirements, the above-described disclosure may be applied.

The UE capability related to the applicability and operation of the above-described disclosure may be defined, may be reported to the base station 10 and/or the terminal 20, or may not be reported.

The SL transmission of the UE may be any of PSCCH, PSSCH, PSFCH, S-SSB, and SL-PRS, or different channels or signals may be applied to each operation of the embodiments.

At least one of the SL transmissions of the UE may be UL transmission.

The embodiment may be applied to any of resource selection, resource reselection, re-evaluation, and preemption checking.

The above disclosure is not limited to the above-described case of the terminal-to-terminal direct communication, and may be applied to other similar cases.

The above disclosure is not limited to the V2X terminal, and may be applied to a terminal that performs D2D communication.

### Device Configuration

Next, a functional configuration example of the base station 10 and the terminal 20 for performing the processes and operations described above will be described. The base station 10 and the terminal 20 include functions for implementing the embodiments described above. However, each of the base station 10 and the terminal 20 may have only some of the functions in an embodiment.

### Base Station 10

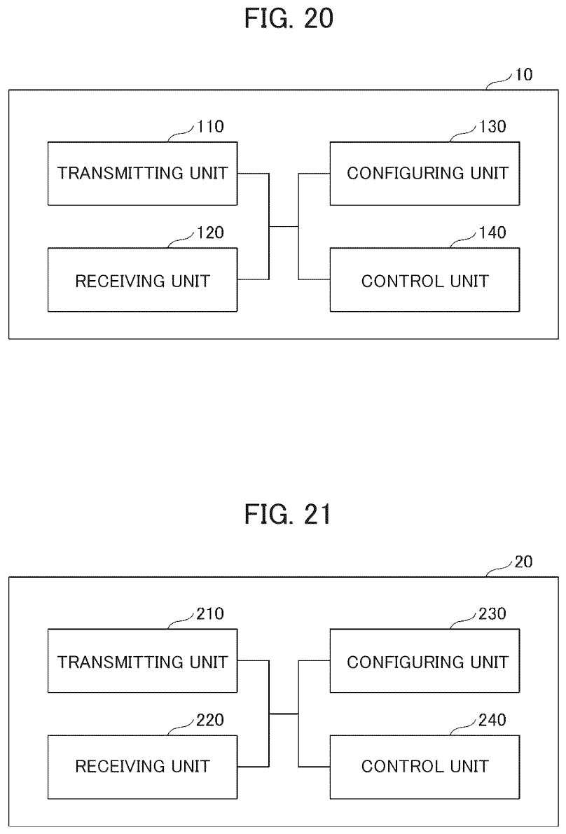

FIG. 20 is a diagram illustrating an example of a functional configuration of the base station 10. As illustrated in FIG. 20, the base station 10 includes a transmitting unit 110, a receiving unit 120, a configuring unit 130, and a control unit 140. The functional configuration illustrated in FIG. 20 is merely an example. Any functional classification and any functional unit name may be used as long as the operations according to the embodiments can be performed.

The transmitting unit 110 has a function of generating a signal to be transmitted to the terminal 20 and wirelessly transmitting the signal. The receiving unit 120 has a function of receiving various signals transmitted from the terminal 20 and acquiring, for example, information of a higher layer from the received signals. The transmitting unit 110 has a function of transmitting NR-PSS, NR-SSS, NR-PBCH, a DL/UL control signal, a DL reference signal, and the like to the terminal 20.

The configuring unit 130 stores configuration information configured in advance and various types of configuration information to be transmitted to the terminal 20 in a storage device, and reads them from the storage device as necessary. The contents of the configuration information are, for example, information related to configuration of D2D communication.

As described in the embodiment, the control unit 140 performs processing related to configuration for the terminal 20 to perform D2D communication. The control unit 140 transmits scheduling of the D2D communication and the DL communication to the terminal 20 via the transmitting unit 110. The control unit 140 receives information related to the HARQ response of the D2D communication and the DL communication from the terminal 20 via the receiving unit 120. The functional unit related to signal transmission in the control unit 140 may be included in the transmitting unit 110, and the functional unit related to signal reception in the control unit 140 may be included in the receiving unit 120.

### Terminal 20

FIG. 21 is a diagram illustrating an example of a functional configuration of the terminal 20. As illustrated in FIG. 21, the terminal 20 includes a transmitting unit 210, a receiving unit 220, a configuring unit 230, and a control unit 240. The functional configuration illustrated in FIG. 21 is merely an example. Any functional classification and any functional unit name may be used as long as the operations according to the embodiments can be performed.

The transmitting unit 210 creates a transmission signal from the transmission data and wirelessly transmits the transmission signal. The receiving unit 220 receives various signals wirelessly and acquires signals from higher layers from the received signal of the physical layer. The receiving unit 220 has a function of receiving NR-PSS, NR-SSS, NR-PBCH, a DL/UL/SL control signal, or a reference signal, or the like transmitted from the base station 10. For example, the transmitting unit 210 transmits a physical sidelink control channel (PSCCH), a physical sidelink shared channel (PSSCH), a physical sidelink discovery channel (PSDCH), a physical sidelink broadcast channel (PSBCH), and the like to another terminal 20 as D2D communication, and the receiving unit 220 receives PSCCH, PSSCH, PSDCH or PSBCH, or the like from another terminal 20.

The configuring unit 230 stores various types of configuration information received from the base station 10 or the terminal 20 by the receiving unit 220 in a storage device, and reads them from the storage device as necessary. The configuring unit 230 also stores configuration information configured in advance. The contents of the configuration information are, for example, information related to configuration of D2D communication.

As described in the embodiment, the control unit 240 controls D2D communication for establishing an RRC connection with another terminal 20. The control unit 240 performs processing related to a power saving operation. The control unit 240 performs processing related to HARQ of the D2D communication and the DL communication. The control unit 240 transmits, to the base station 10, information related to the HARQ response of the D2D communication and the DL communication from the base station 10 to another scheduled terminal 20. The control unit 240 may schedule the D2D communication to another terminal 20. The control unit 240 may autonomously select a resource to be used for D2D communication from the resource selection window on the basis of the result of sidelink sensing, or may perform re-evaluation or preemption. The control unit 240 performs processing related to power saving in transmission and reception of D2D communication. The control unit 240 performs processing related to inter-terminal coordination in D2D communication. The control unit 240 performs processing related to LBT in D2D communication. The functional unit related to signal transmission in the control unit 240 may be included in the transmitting unit 210, and the functional unit related to signal reception in the control unit 240 may be included in the receiving unit 220.

### Hardware Configuration

Note that the block diagrams (FIG. 20 and FIG. 21) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, functional block (components) to implement a function of transmission may be referred to as a “transmitting section (transmitting unit)”, a “transmitter”, and the like. The method for implementing each component is not particularly limited as described above.

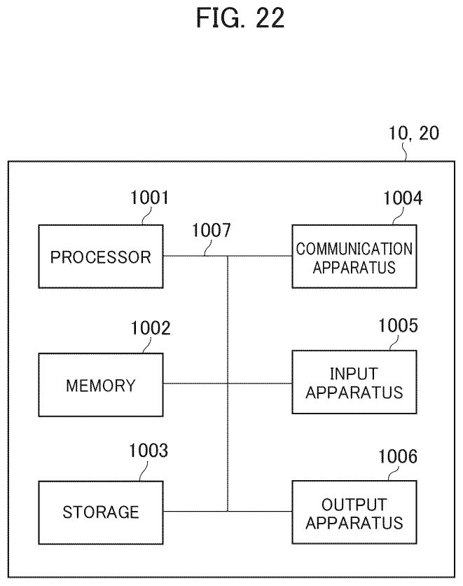

The base station 10, the terminal 20 and the like in one embodiment of the present disclosure may function as a computer that executes the processes of the radio communication method of the present disclosure. FIG. 22 is a diagram to illustrating an example of a hardware configuration of the base station 10 and the terminal 20 according to one embodiment of the present disclosure. The base station 10 and the terminal 10 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a unit, and so on can be interchangeably interpreted. The hardware configuration of the base station 10 and the terminal 20 may be configured to include one or more of apparatuses shown in the drawings, or may be configured not to include part of apparatuses.

Each function of the base station 10 and the terminal 20 is implemented, for example, by allowing certain software (programs) to be read on hardware such as the processor 1001 and the memory 1002, and by allowing the processor 1001 to perform calculations to control communication communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, the control unit 140, the control 240, and the like described above may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control unit 140 of the base station 10 shown in FIG. 20 may be implemented by a control program which is stored in the memory 1002 and is operated by the processor 1001. Also, for example, the control unit 240 of the terminal 20 shown in FIG. 21 may be implemented by a control program which is stored in the memory 1002 and is operated by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the communication method according to one embodiment of the present disclosure.

The storage 1003 is a computer-readable recording medium, and may be constituted with, for example, at least one of an optical disk such as a Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and other appropriate storage media. The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, a transmitting and receiving antenna, an amplifier unit, a transmitting and receiving unit, a transmission channel interface and the like may be implemented by the communication apparatus 1004. The transmitting and receiving unit may be realized by physically or logically separating it into a transmitting unit and a receiving unit.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the terminal 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

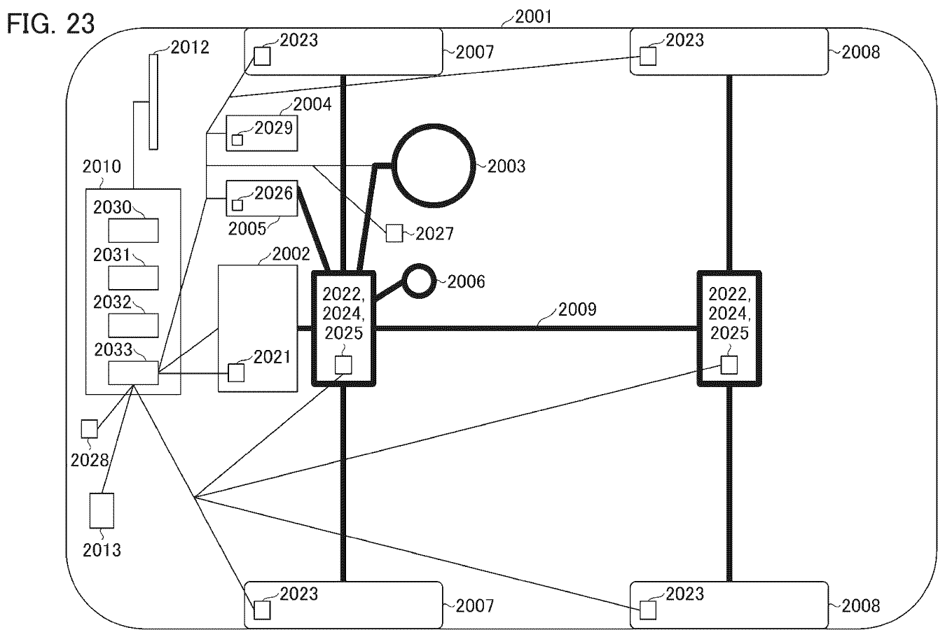

FIG. 23 illustrates an example of a configuration of a vehicle 2001. As illustrated in FIG. 23, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013. Each aspect/embodiment described in the present disclosure may be applied to a communication apparatus mounted in the vehicle 2001, or applied to a communication module 2013, for example.

The drive unit 2002 may include, for example, an engine, a motor, and a hybrid of an engine and a motor. The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021 to 2027 provided in the vehicle 2001. The electronic control unit 2010 may be referred to as an ECU (Electronic control unit)

The signals from the various sensors 2021 to 2029 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUS controlling these devices. The information service unit 2012 provides various types of multimedia information and multimedia services to the occupants of the vehicle 2001 by using information obtained from the external device through the communication module 2013 or the like. The information service unit 2012 may include an input device (e.g., a keyboard, a mouse, a microphone, a switch, a button, a sensor, a touch panel or the like) receiving an input from outside, and/or an output device (e.g., a display, a speaker, an LED lamp, a touch panel or the like) performing an output to outside.

A driving support system unit 2030 includes: various devices for providing functions of preventing accidents and reducing driver's operating loads such as a millimeter wave radar, a LIDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, and an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2029 provided in the vehicle 1.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, the base station, a mobile station, or the like.

The communication module 2013 may transmit to external devices through radio communication, at least one of signals from the various sensors 2021 to 2028 described above, which are input to the electronic control unit 2010, information obtained based on the signals, and information based on an input from outside (user), which is obtained via the information service unit 2012. The electronic control unit 2010, the various sensors 2021 to 2028, the information service unit 2012 and the like may be referred to as an input unit receiving an input. For example, the PUSCH transmitted by the communication module 2013 may include information based on the input.

The communication module 2013 receives various types of information (traffic information, signal information, inter-vehicle information, etc.) transmitted from the external devices and displays the received information on the information service unit 2012 provided in the vehicle. The information service unit 2012 may be referred to as an output unit outputting information (for example, outputting information to devices such as a display and a speaker based on the PDSCH received by the communication module 2013 (or data/information decoded from the PDSCH). In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2029, etc., mounted in the vehicle 2001.

### Supplementary Information on the Embodiment

The above is an explanation of the embodiment, but the disclosed invention is not limited to such an embodiment, and those skilled in the art will understand various alternative, modified, substituted, and replacement examples. The explanation uses specific numerical examples to facilitate understanding of the invention, but unless otherwise specified, these numerical examples are merely examples, and any appropriate value may be used. The division of items in the above explanation is not essential to the invention, and matters described in two or more items may be used in combination as necessary, and matters described in one item may be applied to matters described in another item (as long as inconsistencies do not arise). The boundaries of functional or processing units in the functional block diagrams do not necessarily correspond to the boundaries of physical components. The operation of multiple functional units may be carried out by a single physical component, or the operation of a single functional unit may be carried out by multiple physical components. The processing sequence described in the embodiment may be interchanged as long as there is no contradiction. For the sake of convenience in explaining the processing, the base station 10 and the terminal 20 are described using the functional block diagrams, but such devices may be implemented in hardware, software, or a combination of them. The software that operates on the processor of the base station 10 according to an embodiment and the software that operates on the processor of the terminal 20 according to an embodiment may be stored in any suitable storage medium, such as random access memory (RAM), flash memory, read-only memory (ROM), EPROM, EEPROM, registers, hard disk (HDD), removable disk, CD-ROM, database, server, etc.

Notification of information is by no means limited to the aspects/embodiments described in the present disclosure, and other methods may be used as well. For example, notification of information in the present disclosure may be implemented by using physical layer signaling (for example, Downlink Control Information (DCI), Uplink Control Information (UCI)), higher layer signaling (for example, Radio Resource Control (RRC) signaling, Medium Access Control (MAC) signaling, broadcast information (Master Information Block (MIB), System Information Block (SIB), and so on)), and other signals or combinations of these. Also, RRC signaling may be referred to as an “RRC message”, and can be, for example, an RRC Connection Setup message, an RRC Connection Reconfiguration message, and so on.

The aspects/embodiments illustrated in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth-generation mobile communication syste (xG) (xG (x is an integer or a decimal, for example) ), Future Radio Access (FRA), New Radio (NR), New radio access (NX), Future generation radio access (FX), W-CDMA (registered trademark) , GSM (registered trademark), CDMA 2000, Ultra Mobile Broadband (UMB), IEEE 802.11 (Wi-Fi (registered trademark) ), IEEE 802.16 (WiMAX (registered trademark) ), IEEE 802.20, Ultra-WideBand (UWB), Bluetooth (registered trademark), systems that use other adequate systems, next-generation systems that are enhanced, modified, created or defined based on these, and the like. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by the base station 10 may, in some cases, be performed by an upper node of the base station 10. In a network including one or a plurality of network nodes with the base station 10, it is clear that various operations that are performed to communicate with the terminal 20 can be performed by at least one of the base station 10 and one or more network nodes (for example, MME, S-GW, and so on may be possible, but these are not limiting) other than the base station 10. According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies and wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and a term required for understanding of the present specification may be replaced by a term having the Same or similar meaning. For example, at least one of a channel and a symbol may be a signal (signaling). Further, a signal may be a message. Further, the Component Carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g. PUCCH, PDCCH) and information elements may be identified by any suitable names, the various names assigned to these various channels and information elements are not used as limitations.

In the present disclosure, the terms such as a “Base Station (BS)”, a “radio base station”, a “fixed station”, a “NodeB”, an “eNB (eNodeB) ”, a “gNB (gNodeB) ”, an “access point”, a “transmission point”, a “reception point”, a “transmission/reception point”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

The base station can accommodate one or a plurality of (for example, three) cells. When the base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the transmission of information from the base station to the terminal may be interpreted as an instruction of control and operation based on the information from the base station to the terminal.

In the present disclosure, the terms “Mobile Station (MS)”, “user terminal”, “User Equipment (UE)”, and “terminal” may be used interchangeably.

A mobile station may be referred to as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other appropriate terms in some cases by the person skilled in the art.

At least one of the base station and the mobile station may be referred to as a “transmitting apparatus”, a “receiving apparatus”, a “radio communication apparatus”, and so on. Note that at least one of the base station and the mobile station may be a device mounted on a moving object or a moving object itself, and so on. The moving object refers to any movable object, with no restriction on its speed. This includes cases where the moving object is stationary. Examples of the moving object include a vehicle, a transport vehicle, an automobile, a motorcycle, a bicycle, a connected car, an excavator, a bulldozer, a wheel loader, a dump truck, a forklift, a train, a bus, a cart, a rickshaw, a ship (including other watercraft), an aircraft, a rocket, an artificial satellite, a drone (registered trademark), a multicopter, a quadcopter, a balloon, and an object carried on or by these, and is not limited to these examples. Furthermore, the moving object may be a moving object that operates autonomously based on operational instructions. The moving object may be a vehicle (for example, a car, an airplane, and the like), may be a moving object which moves unmanned (for example, a drone, an automatic operation car, and the like), or may be a robot (a manned type or unmanned type). Note that at least one of the base station and the mobile station also includes an apparatus which does not necessarily move during communication operation. For example, at least one of the base station and the mobile station may be an Internet of Things (IoT) device such as a sensor.

Furthermore, the base station in the present disclosure may be interpreted as a user terminal. For example, each aspect/embodiment of the present disclosure may be applied to the structure that replaces a communication between the base station and the user terminal with a communication between a plurality of terminals 20 (for example, which may be referred to as “Device-to-Device (D2D)”, “Vehicle-to-Everything (V2X)”, and the like). In this case, the terminal 20 may have the functions of the base station 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as the base station. In this case, the base station may have the functions of the user terminal described above.

As used herein, the term “determining” may encompasses a wide variety of actions. For example, “determining” may be regarded as judging, calculating, computing, processing, deriving, investigating, looking up, search inquiry (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing and the like. That is, “determining” may be regarded as a certain type of action related to determining. Furthermore, “determining” may be regarded as “assuming”, “expecting”, “considering”, and the like.

The term “connected” or “coupled” or any variation thereof means any direct or indirect connection or coupling between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS”, and may be referred to as a “pilot”, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may be constituted of one or a plurality of frames in the time domain. Each of one or a plurality of frames in the time domain may be referred to as a “subframe”. Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a SubCarrier Spacing (SCS), a bandwidth, a symbol length, a cyclic prefix length, a Transmission Time Interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols less than the number of slots. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, the base station performs, for each terminal 20, scheduling of allocating radio resources (such as a frequency bandwidth and transmit power available a for each terminal 20) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot”, or the like. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB) )”, a “Sub-Carrier Group (SCG)”, a “Resource Element Group (REG)”, a “PRB pair”, an “RB pair” and so on.

Furthermore, a resource block may be constituted of one or a plurality of Resource Elements (REs). For example, one RE may correspond to a radio resource field of one subcarrier and one symbol.

A Bandwidth Part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and the terminal 20 may not need to assume to transmit/receive a certain signal/channel outside the active BWP(s). Note that a “cell”, a “carrier”, and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe r radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

In the present disclosure, where an article is added by translation, for example “a”, “an”, and “the”, the disclosure may include that the noun following these articles is plural.

In this disclosure, the term “A and B are different” may mean “A and B are different from each other”. It should be noted that the term “A and B are different” may mean “A and B are different from C”. Terms such as “separated” or “combined” may be interpreted in the same way as the above-described “different”.

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### Appendix

The above disclosure may be expressed as follows.

A first feature is a terminal including: a communication unit that performs communication of a sidelink channel; and a control unit that controls the communication of the sidelink channel, in which the control unit controls transmission of the sidelink channel by a specific method when two or more transmission occasions are usable as a transmission occasion of a sidelink feedback channel transmitting a feedback.

A second feature is the terminal in the first feature, in which the sidelink channel includes at least one of a sidelink control channel and a sidelink shared channel separately from the sidelink feedback channel, and the control unit determines at least one resource of the sidelink control channel and the sidelink shared channel based on the two or more transmission occasions as the specific method.

A third feature is the terminal in the first feature or the second feature, in which the control unit transmits the sidelink feedback channel in a specific occasion selected from the two or more transmission occasions as the specific method.

A fourth feature is a radio communication method including: a step A of performing communication of a sidelink channel; and a step B of controlling the communication of the sidelink channel, in which the step A includes a step of controlling transmission of the sidelink channel by a specific method when two or more transmission occasions are usable as a transmission occasion of a sidelink feedback channel transmitting a feedback.

### Explanation of Reference Numerals

10 base station
110 transmitting unit
120 receiving unit
130 configuring unit
140 control unit
20 terminal
210 transmitting unit
220 receiving unit
230 configuring unit
240 control unit
1001 processor
1002 memory
1003 storage
1004 communication apparatus
1005 input apparatus
1006 output apparatus
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 revolution sensor
2023 pneumatic sensor
2024 vehicle speed sensor
2025 acceleration sensor
2026 brake pedal sensor
2027 shift lever sensor
2028 object detection sensor
2029 accelerator pedal sensor
2030 driving support system unit
2031 microprocessor
2032 memory (ROM, RAM)
2033 communication port (IO port)

1-4. (canceled)

5. A terminal comprising:
a receiving unit that receives a sidelink shared channel;
a transmitting unit that transmits a sidelink feedback channel for the sidelink shared channel; and
a control unit that determines to transmit the sidelink feedback channel in an n-th transmission occasion when the sidelink feedback channel is not able to be transmitted in a transmission occasion before the n-th transmission occasion in a case where two or more transmission occasions are usable as a transmission occasion of the sidelink feedback channel.

6. The terminal according to claim 5, wherein the control unit determines to cancel transmission of the sidelink feedback channel in the n-th transmission occasion when the sidelink feedback channel is able to be transmitted in a transmission occasion before the n-th transmission occasion.

7. A terminal comprising:
a transmitting unit that transmits a sidelink shared channel; and
a receiving unit that receives a sidelink feedback channel for the sidelink shared channel, wherein
the sidelink shared channel is determined to be transmitted using a resource after a last reception occasion of two or more reception occasions in a case where the two or more reception occasions are usable as a reception occasion of the sidelink feedback channel.

8. A radio communication system comprising a first terminal and a second terminal, wherein
the first terminal transmits a sidelink shared channel,
the second terminal transmits a sidelink feedback channel for the sidelink shared channel, and
the second terminal determines to transmit the sidelink feedback channel in an n-th transmission occasion when the sidelink feedback channel is not able to be transmitted in a transmission occasion before the n-th transmission occasion in a case where two or more transmission occasions are usable as a transmission occasion of the sidelink feedback channel.

9. A radio communication system comprising a first terminal and a second terminal, wherein
the first terminal transmits a sidelink shared channel,
the second terminal transmits a sidelink feedback channel for the sidelink shared channel, and
the first terminal determines to transmit the sidelink shared channel using a resource after a last reception occasion of two or more reception occasions in a case where the two or more reception occasions are usable as a reception occasion of the sidelink feedback channel.

10. A radio communication method comprising:
a step of receiving a sidelink shared channel;
a step of transmitting a sidelink feedback channel for the sidelink shared channel; and
a step of determining to transmit the sidelink feedback channel in an n-th transmission occasion when the sidelink feedback channel is not able to be transmitted in a transmission occasion before the n-th transmission occasion in a case where two or more transmission occasions are usable as a transmission occasion of the sidelink feedback channel.

11. A radio communication method comprising:
a step of transmitting a sidelink shared channel;
a step of receiving a sidelink feedback channel for the sidelink shared channel; and
a step of determining to transmit the sidelink shared channel using a resource after a last reception occasion of two or more reception occasions in a case where the two or more reception occasions are usable as a reception occasion of the sidelink feedback channel.
